(19) United States
(12) Patent Application Publication
(10) Pub. No.: US 2010/0209551 A1
(43) Pub. Date: Aug. 19, 2010

(54) Reclosable Packages for Confectionery Products

(76) Inventors: Ujjaini Mitra-Shah, Chicago, IL (US); James Bougoulas, Chicago, IL (US); Yoichiro Ishikawa, Glenview, IL (US)

Correspondence Address: WRIGLEY & DREYFUS 28455;BRINKS HOFER GILSON & LIONE, P.O. BOX 10395, CHICAGO, IL, 60610, US

(21) Appl. No.: 12/446,073

(22) PCT Filed: Oct. 18, 2007
(86) PCT No.: PCT/US07/81860

§ 371 Date: Mar. 17, 2010

Related U.S. Application Data
(60) Provisional application No. 60/852,814, filed on Oct. 19, 2006.

(51) Int. Cl. B65D 75/62; B65D 85/60; A23G 4/00; B65D 43/14

(52) U.S. Cl. 426/5; 426/122; 220/359.1

(57) ABSTRACT

A reclosable package having an opening panel such that when the panel is in a closed position, the confectionery product within the package is retained and when the panel is in an open position, the product is exposed for dispensing. The confectionery product may be oriented in a manner with respect to the opening defined by the opening panel to provide easy access to a consumer.

This application claims priority to U.S. Application No. 60/852,814 filed Oct. 19, 2006, the entire contents of which are incorporated herein by reference.

The present invention relates to a reclosable product package for storing and dispensing products, particularly confectionery products and more particularly confectionery products and chewing gum. The present invention also relates to a package assembly having a reclosable opening for a package containing such products.

Certain confectionery products such as confectionery products and gum are provided as individual pieces in a package. Oftentimes, it is desirable to protect these products from various elements yet retain the products within the package when the package is closed. It may also be desirable to provide a flexible package which is capable of being folded after one or more of the products have been removed for consumption while maintaining the functionality of the reclose feature and avoiding mutilation of the remaining product. It may further be desirable to provide a flexible package in which only one or a few pieces of confectionery product are exposed when the package is opened to reduce the risk of contamination or deterioration caused by exposure to the environment.

### SUMMARY

The present invention provides a flexible, reclosable package for storing and dispensing individual pieces of confectionery product, particularly confectionery products and chewing gum.

The present invention further provides a flexible, reclosable package for storing and dispensing individual pieces of confectionery product, particularly confectionery products and chewing gum, in which most or all of the pieces of product are exposed when the package is opened.

The present invention further provides a flexible, reclosable package for storing and dispensing individual pieces of confectionery product, particularly chewing gum, in which the package may be folded by the consumer to reduce the size of the package after a portion of the confectionery product has been removed without such folding impairing the functionality of the reclose feature or causing damage to the remaining product pieces or the package itself.

The reclosable package for confectionery products according to the present invention includes a laminated sheet comprising an inner layer and an outer layer wherein the inner layer is oriented toward the inside of the package and the outer layer is oriented toward the outside of the package. A first score line extends substantially through the inner layer but does not extend into the outer layer. A second score line extends at least substantially through the outer layer but does not extend into the inner layer. The first and second score lines are laterally offset from each other to define an opening panel in the package, a marginal region between the first and second score lines, and a surrounding region of the sheet outside of the marginal region. A laminating adhesive is disposed between the inner and outer layers and extends substantially throughout the surrounding region. A releasable adhesive may be disposed between the inner and outer layers in the marginal region. It may be desirable to provide a portion of the region that is free of the releasable adhesive to define a tongue or grip for lifting the opening panel and to provide a tolerance for imprecision in application of the adhesives. Similarly, a portion of the surrounding region may be free of laminating adhesive to allow for imprecision in the application of adhesive. Typically, the adhesive free areas will surround the boundary of the marginal and surrounding regions.

In one aspect, the package defines a front surface, a rear surface opposite the front, a first side, a second side opposite the first side, a third side and a fourth side opposite the third side. In this aspect, the opening panel of the package will be constructed so as to be effective to open at least a portion of the front and the first side of the package. Desirably, the package is formed from flexible material such as plastics including polypropylene and polyethylene and foil.

In one embodiment of the present invention, a plurality of confectionery products, are contained within the package. Generally, each product has a first end and a second end to define a length, a third end and a fourth end to define a width, and a first face and a second face to define a thickness wherein the length is greater than the width which, in turn, is greater than the thickness. When the opening panel is in a closed position, the products are retained within the package and when opening panel is an opened position, the products are oriented in a manner to provide access to at least one piece of the product.

In this regard, in one embodiment, when opening panel is an opened position, the products may be oriented such that one of the first face and the second face of at least one of the plurality of confectionery products and one of the first end and the second end of at least one of the plurality of confectionery products is exposed. When the package has an opposed front and rear, an opposed first and second side, and an opposed third and fourth side, the first end of the plurality of confectionery products may have a plane that is parallel to a plane of the first side of the package. Furthermore, in this embodiment, the first face of the product will be substantially parallel to the front of the package. By orienting the product in the above manner, most or all of the pieces of the confectionery product are exposed when the opening panel is in the open position thus facilitating removal by the consumer.

One of skill in the art will understand that the sides of the package may be rounded and a tangent of the side may define the plane of that side of the package and it will be roughly perpendicular to the front and rear of the package. Similarly, it may be that the four ends of the product are not truly planar in nature due to ordinary irregularities caused by the manufacturing process. In such instances, it will be understood that the plane of an end will be considered to be perpendicular to the lines formed by the adjacent ends and to the faces of the confectionery product.

In another embodiment, when the opening panel is in an opened position, the products may be oriented within the package such that one of the first face and the second face of at least one of the plurality of confectionery products and one of the third end and fourth end of at least one of the plurality of confectionery products is exposed. When the package includes opposed front and rear surfaces, opposed first and second sides, and opposed third and fourth sides, the third end of the product will have a plane that is parallel to the first side of the package and the first face of the plurality of confectionery products will have a plane that is parallel to a plane of the front surface of the package.

In yet another embodiment, when the opening panel is in an opened position, the products will be oriented within the package such that one of the third end and the fourth end of at least one of the plurality of confectionery products and one of the first end and the second end of at least one of the plurality of confectionery products is exposed. When the package includes opposed front and rear surfaces, opposed first and second sides, and opposed third side and fourth side, the third end of the confectionery product will have a plane that is parallel to the plane of the front surface of the package and the first end of the plurality of confectionery products will have a plane that is parallel to the plane of the first side of the package. By orienting the product in the above manner, the number of pieces of the product that is exposed is reduced to one or a few.

In yet another embodiment, when the opening panel is in an opened position, the products will be oriented within the package such that one of the third end and the fourth end of at least one of the plurality of confectionery products and one of the first face and the second face of at least one of the plurality of confectionery products is exposed. When the package includes opposed front and rear surfaces, opposed first and second sides, and opposed third and fourth sides, the third end of the at least one confectionery products will have a plane that is parallel to the plane of the front surface of the package and the first face of the plurality of confectionery products will have a plane that is parallel to the plane of the first side of the package. By orienting the product in the above manner, the number of pieces of the product that is exposed is reduced to one or a few.

In any of the above described embodiments, it is contemplated that the package may be folded by the consumer to reduce the size of the package after one or more of the confectionery products has been removed. In this regard, it is preferable that the package be constructed so as to maintain flexibility in the plane perpendicular to the void created by the removed piece(s). In other words, flexibility is to be maintained along the line of anticipated folding. Generally, this means that the package will be flexible to allow folding along a line parallel to the third end of the confectionery product, although it is possible to construct the package so that folding along other lines is encouraged. In the present invention, this flexibility allows the package to be reduced in size while maintaining the functionality of the reclose feature and the esthetic appearance of the package. While the package may be flexible in all planes, it is anticipated that the package may be reinforced or stiffened in planes other that the one in which folding is anticipated.

The present invention also contemplates a method of making a reclosable package. The method includes providing a first and a second substrate. A releasable adhesive is applied to one of the first or second substrate. The substrates are then joined, such as by laminating them together. The releasable adhesive is selected so that a portion of the releasable adhesive transfers to the other of the first or second substrate during the joining operation and so that the substrates can be repeatedly separated and adhesively rejoined.

### BRIEF DESCRIPTION OF THE DRAWINGS

FIG. 1 shows an individual flexible package according to one embodiment of the present invention with the opening panel in an open position to expose the chewing gum oriented in one position according to one aspect of the present invention.

FIG. 2 shows the package of FIG. 1 with the opening panel in a closed position.

FIG. 3 shows an individual flexible package according to another embodiment of the present invention with the opening panel in an open position to expose the chewing gum oriented in one position according to one aspect of the present invention.

FIG. 4 shows an individual flexible package according to yet another embodiment of the present invention with the opening panel in an open position to expose the chewing gum oriented in one position according to one aspect of the present invention.

FIG. 5 shows an individual flexible package according to yet another embodiment of the present invention with the opening panel in an open position to expose the chewing gum oriented in one position according to one aspect of the present invention.

FIG. 6 is a view of a portion of a first side of an outer layer for one embodiment of a package of the present invention showing a pattern of adhesive applied to the first side of the outer layer so that the outer layer can be adhered to a first side of an inner layer.

FIG. 7 is a view of a portion of a first side of an outer layer for another embodiment of a package of the present invention showing a pattern of adhesive applied to the first side of the outer layer so that the outer layer can be adhered to a first side of an inner layer.

FIG. 8 is a view of a portion of a second side of an inner layer, which will form the inner surfaces of the package and the other side of which is laminated onto a first side of the outer layer of any of the embodiments shown in FIGS. 6 and 7 to form a laminate roll stock.

FIG. 9 is a view of a portion of the second side of the outer layer, which will form the outer surfaces of the package, the other side of which is laminated onto the first side of the inner layer to form a laminate roll stock.

FIG. 10 is a partial cross sectional view of the laminate of FIG. 9 with the adhesive pattern of FIG. 6.

FIGS. 11a-11g show exemplary ends of the outer score line, each being discontinuous from the outer score line.

FIGS. 12a and 12b shows an embodiment of the package according to the present invention where the package is formed from a separate front and rear layers.

FIG. 13 shows an embodiment of the package according to the present invention where the package is formed with a rear side having a seal.

FIGS. 14a and 14b show the rear of the package of FIG. 13 with two different rear seals.

FIG. 15 is a diagrammatic depiction of a method for making a flexible package according to the present invention.

FIG. 16 is a view of the outer layer structure before being laminated to the inner layer structure and after being scored but without any printing.

FIG. 17a is a cross-sectional view of a portion of the package formed by the method of FIG. 15 in a closed configuration.

FIG. 17b is a cross-sectional view of a portion of the package formed by the method of FIG. 15 in an open configuration.

FIG. 18 is a diagrammatic depiction of a method for making a flexible package according to the present invention, which contains features that can be used in the process depicted in FIG. 15.

FIG. 19 shows a container useful for storing and carrying a plurality of individual product packages such as those shown in FIGS. 1-5, each of which can contain a plurality of individual pieces of edible product, particularly chewing gum. The container is shown in an unopened orientation.

FIG. 20 shows the container of FIG. 19 in an opened orientation.

FIG. 21 shows a suitable configuration for a piece of gum that may be stored in the individual product packages.

FIG. 22 shows a suitable configuration for a slab of gum that may be stored in the individual product packages.

### DETAILED DESCRIPTION

The invention is described with reference to the drawings in which like elements are referred to by like numerals. The relationship and functioning of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

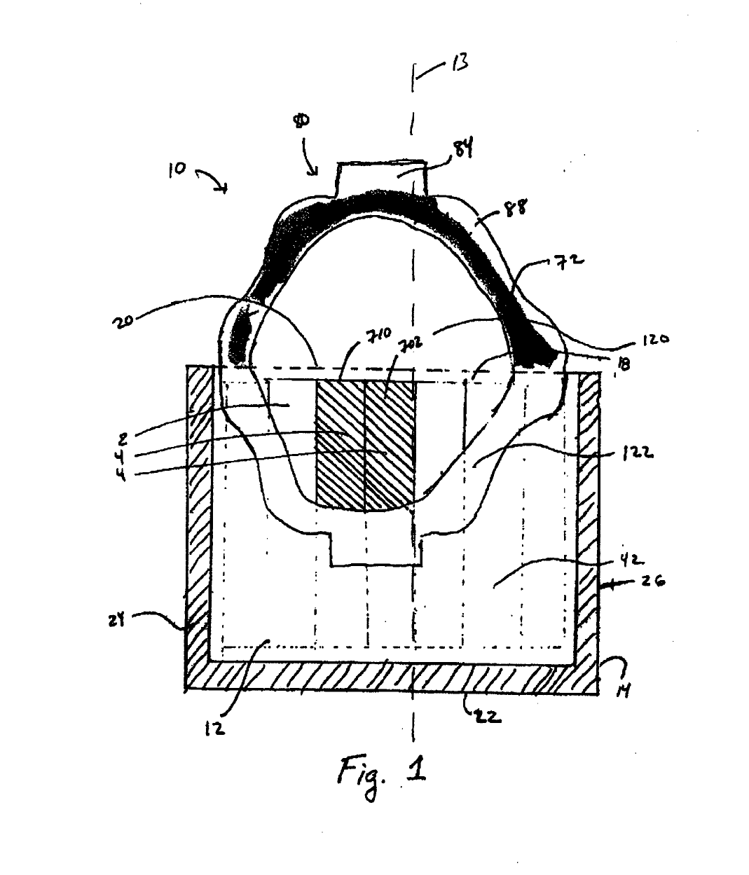

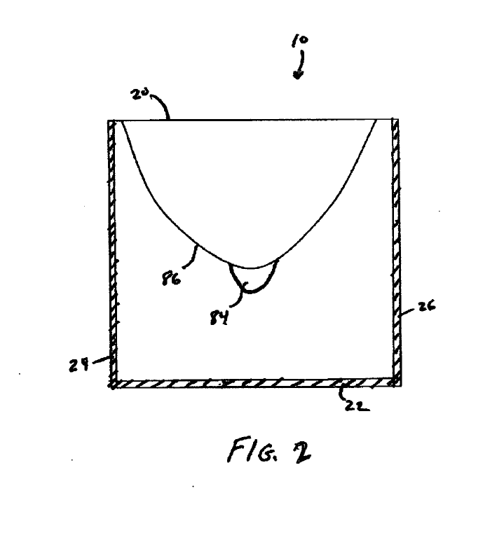

Turning now to FIG. 1, one embodiment of a package 10 of the present invention is shown with an opening panel 80 in an open position to expose the contents 2 of the package. In this embodiment, the package includes opposed front and rear 12, 14, an opposed first side 20 and second side 22, and opposed third and fourth sides 24, 26. The front surface is scored to define an opening panel 80 which extends onto the first side 20 that can be opened to expose the contents 2 stored within the package 10. The package 10 is shown in a closed configuration in FIG. 2.

For ease of reference, in the description provided below, the package 10 of the present invention is described as containing sticks (or tabs) 2 of gum. It is to be understood, however, that the package 10 may also contain other confectionery products. Therefore, a reclosable product package 10 having an array of gum sticks 2 is shown in FIG. 1. The package assembly includes a package 10 to retain and enclose the array of gum sticks 2 as will be described below. An opening panel 80 provides selective access to the contents 2 within the package 10.

As is known gum sticks may be elongate rectangular shaped members that are individually wrapped with a wrapper 4 in a conventional fashion. The wrapper 4 may be a rectangular shaped member typically made of paper or foil. Typically, the longitudinal edges of the wrapper are overlapped and the ends of are turned over against the stick to enclose the stick completely.

FIG. 1 shows gum sticks 2 contained in wrappers 4, where the gum sticks were individually wrapped prior to being placed in the package 10. The wrapper 4 may be a single sheet or may include plural sheets or layers. It is noted that the gum sticks 2 can be placed in an array directly into the package, without being individually wrapped.

While FIG. 1 shows the gum sticks 2 aligned in a single row, it is to be understood that the gum sticks (wrapped or not) can be placed in two or more rows to form an array. When two or more rows are provided, each row may be encircled partially or completely by a wrapper to better contain the individual gum sticks. The array of gum sticks is placed in the package 10 and are retained and enclosed. The wrapper may include an adhesive to releasably hold the individual sticks in the array. A portion of the inside of the package 10 may contain an adhesive to secure the wrapped rows in the package. Alternatively, the package 10 may contain an adhesive on the inside surface to releasably hold or the individual gum sticks in the package until the consumer removes them from the package 10 in the event that row wrappers are not employed.

As shown in the figures, one or more gum sticks may be contained within a flexible package 10 and one or more flexible packages 10 may be provided in a container 800 as will be described in more detail below.

The package 10 is generally a parallelepiped shape and formed of any suitable material. Without desiring to being limited to any particular configuration or material, it is contemplated that the package 10 can be formed a flexible plastic material, such as polyethylene (including but not limited to low density polyethylene and linear low-density polyethylene), polypropylene, mixtures or laminates of such, and other flexible plastics. The package could also be formed from metalized plastics, paper, laminated paper material, or other laminates. While it is contemplated that the package can be formed from a variety of suitable materials, for ease of understanding and description the package 10 and its construction will be described as being formed from a flexible plastic material such as polypropylene.

Accordingly, the package 10 is formed from a laminate 30 that includes a polypropylene film and optionally a polyethylene film. In one aspect, the package 10 is formed from a laminate 30 that includes a metal layer 122 disposed between two layers of polypropylene 42, 120.

In general, the present invention also contemplates a method of making a reclosable package. The method includes providing a first and a second substrate. A releasable adhesive is applied to one of the first or second substrate. The substrates are then joined, such as by laminating them together. The releasable adhesive is selected so that a portion of the releasable adhesive transfers to the other of the first or second substrate during the joining operation and so that the substrates can be repeatedly separated and adhesively rejoined. The releasable adhesive may be applied to a first region of the first or second substrate and a permanent adhesive may be applied to a second region of the first or second substrate. Typically, the second region differs from the first region. In one embodiment, as will be appreciated from the discussion below, the releasable adhesive may be a mixture of two adhesives.

Turning now to FIG. 6, one method of forming of one embodiment of the package 10 will be explained. Briefly, this method includes creating a laminate from a first and second material, scoring each side of the laminate, cutting the laminate, filling the laminate with the desired contents, forming the package, and sealing appropriate areas to provide the package 10. While several methods of forming the package 10 are described below, each will produce a package according to the present invention.

Accordingly, a first layer of material 40 may be unwound from a web (not shown). The first (or outer) layer 40 may be formed of polypropylene 42 and it includes a first side 44, a second side 46, a longitudinal direction 48, and a lateral direction 50 as shown in FIGS. 6 and 10. Desirably, the polypropylene 42 is an oriented polypropylene with the orientation in the lateral direction 50. As one skilled in the art will appreciate, orientation in this direction provides a higher resistance to tearing in the longitudinal direction 48 as compared to the lateral direction 50. While FIG. 6 depicts a continuous layer of material, the figure also identifies a first end 52 and a second end 54, which when cut and joined to each other (not necessarily in that order) in a later operation will form one side 22 of the package.

As used in the specification, reference to an outer layer (and for that matter, an inner layer) means a single layer of material or a plurality of layers of the same or different materials acting as a single layer for the purposed of the present invention.

The first side 44 of the first (or outer) layer 40 is patterned with adhesive so that another layer may be adhered to the first side 44 of the first (or outer) layer 40. The second side 46 of the first (or outer) layer 40 will form the outer surfaces of the package 12 and 14, as will become clear. Typically, the first (or outer) layer 40 is patterned with a permanent laminating adhesive 70, a releasable adhesive 72 (such as a pressure sensitive adhesive) as it is being unwound, and before it is adhered to a second (or inner) layer 100.

FIG. 6 shows one pattern of adhesive application. As shown in FIG. 6, a fold line 60 is depicted at about the middle of the longitudinal length of the first (or outer) layer 40. It is to be understood that the fold line 60 is not provided on the first (or outer) layer 40 but instead it represents the portion of the first (or outer) layer 40 where the laminate 30 may be folded in a later operation to define a first side 20 of the package 10. The fold line 60 defines a top section 62 and a bottom section 64 of the first (or outer) layer 40.

In the embodiment shown in FIG. 6, a permanent laminating adhesive 70 such as any of those well known to those of skill in the art is applied to a sufficient portion of the top section 62 of the first (or outer) layer 40 and only to a portion of the bottom section 64. The permanent laminating adhesive 70 may be applied to the entire portion of the top section, if desired. Put another way, the laminating adhesive 70 is distributed throughout the surrounding region to at least the extent necessary to effectively join the inner layers 100 and the outer layers 40 to allow the package 10 to function as intended. The laminating adhesive 70 may be applied evenly throughout the entirety of the surrounding region. Alternatively, it may be applied evenly to key areas where delamination could otherwise occur. It is also contemplated to provide the laminating adhesive 70 as a repeating or random pattern in discrete areas such as by using a dot matrix or cross hatch patterns. Of course, one or more combinations could also be used.

In the bottom section 64, a first smile area 82 is defined. The first smile area 82 includes a releasable adhesive 72 such as a releasable pressure sensitive adhesive such as any of those known to those of skill in the art. A releasable adhesive 72 functions to join the outer 40 and inner 100 layers and it has a relatively low bond force to allow easy separation of the outer 40 and inner 100 layers. In addition, the releasable adhesive is capable of re-adhering the outer 40 and inner 100 layers a sufficient number of times (i.e., a sufficient number of iterations of joining and separating the layers). An adhesive-free area 74 may be provided adjacent to at least a portion of the releasable adhesive area 72. The adhesive-free area 74 does not contain any adhesive, the reasons for which will become apparent upon further reading of the description.

FIG. 7 shows an alternative pattern of applying the adhesive to the first side 44 of the first (or outer) layer 40. This pattern is similar to that of FIG. 6 except that the adhesive-free area 74 is limited simply to a tongue tip portion 84.

A second (or inner) layer of material 100 may be unwound from a web (not shown). The second (or inner) layer 100 may be formed from any suitable material as noted above. The material desirably is formed from a composite or laminate such that one layer can be scored with a laser while the other layer resists scoring. For example, the material may be a laminate of paper and metal or foil, or a laminate of a flexible plastic material and metal or foil. In one aspect of the present invention as illustrated in FIG. 10, the second (or inner) layer 100 is a formed from metalized polypropylene, i.e., a layer of polypropylene 120 and a layer of metal 122 provided on one side of the polypropylene 120.

The second (or inner) layer 120 has a first side 102 (best seen in FIG. 10), a second side 104 (best seen in FIG. 8), a longitudinal direction 106 and a lateral direction 108. Desirably, the polypropylene is an oriented polypropylene with the orientation in the lateral direction 108.

As the second (or inner) layer of material 100 is unwound, the first side 102 of the second (or inner) layer 100 is joined with the first side 44 of the first layer 40. The first layer 40 and the second (or inner) layer 100 are laminated in a manner such that the layer of metal or foil 122 is disposed between the layers of the polypropylene 42 and 120 and such that a laminate 30 is formed. In other words, the layer of metal 122 is in contact with the adhesive 70, 72 provided on the first side 44 of the first layer 40. Desirably, the second (or inner) layer 100 is securely adhered to the first layer 40.

Optionally, a heat-sealing layer 124 such as a layer of polyethylene may be provided on the second side 104 of the second (or inner) layer 100. Alternatively, other layers may be provided on the second side 104 or the second (or inner) layer 100 as is known to those of skill in the art.

FIG. 8 shows the second side 104 of the second (or inner) layer 100. It is to be understood that FIG. 8 also shows the laminate 30 with the second side 104 of the second layer 100 visible. While FIG. 8 depicts a continuous layer of laminate, the figure also identifies a first end 103 and a second end 105, which, when cut and joined to each other by folding along fold line 110 in a later operation, will form the one side 22 of the package. It is to be understood that the fold line 110 is not provided on the second (or inner) layer 100 but instead it represents the portion of the second (or inner) layer 100 where the laminate 30 may be folded in a later operation to define the a first side 20 of the package 10 which may include a portion of the opening panel. The fold line 110 defines two sections 112, 114 of the second layer 100.

As seen in FIG. 8, a score line 132 is created on one section 114 of the second side 104 of the second (or inner) layer 100. This scoring may be performed after the laminate 30 is formed. Alternatively, the scoring may be performed before the second (or inner) layer 100 is laminated to the first (or outer) layer 4. Desirably, the score line 132 is created by laser scoring and, as shown in FIG. 8, can be considered to define an inner smile cut 132. The inner smile cut or score line 132 will also define an inner smile area 130, as will become clear upon reading the following description. The term score line is means a weakened line that is intended to assist the consumer in separating the material along the line. The score line may be a continuous line cut to partial depth of the layer or it may be a linear series of intermittent cuts to a full or partial depth of the layer. It is understood that the score line may be straight, curved, or a combination of these along the length of the score line.

The scoring of the score line 132 is on the polypropylene layer 120 only (or the polyethylene and heat seal layers, if a heat seal layer is present) and does not score beyond the metal layer 122 (i.e., it does not score the first (or outer) layer 40). The depth of the laser cut may be controlled in a manner known by those of skill in the art to provide such precision cutting. Specifically, the heat dissipation of the metal layer (or other laser scoring resistant material) reduces the likelihood that it is scored when the power of the laser is controlled for that purpose. By controlling the power of the laser carefully, it may also be possible to score only one layer without the presence of the heat dissipating foil layer.

The section 112 of the second side 104 of the second layer (or inner) 100 may include a releasable adhesive 140 applied along a line or strip. As shown in FIG. 8, the line is shown as oriented in the lateral direction 108. It will be understood by one of skill in the art that the releasable adhesive 140 may be applied in a longitudinal direction 106, as desired to removably adhere the product contained in the package. The releasable adhesive 140 may be applied in a continuous or intermittent manner according to methods well known to those of skill in the art. This adhesive strip 140 may engage some or all of the gum sticks 2 or their wrappers 4 so that when the package 10 is formed; the gum sticks 2 are removably adhesively retained in the package. As a result, the gum sticks 2 may remain positioned in the package 10 even when one or more gum sticks 2 are removed. In addition, the adhesive 140 may prevent the gum sticks from becoming inadvertently dislodged from the package 10, when the opening panel 80 is in an open orientation. It is contemplated that a second strip of releasable adhesive (not shown) may be similarly applied the other section 114 for a similar purpose. This is especially helpful if the package is to contain two or more rows of confectionery pieces.

Turning to FIG. 9, the second side 46 of the laminate 30 is shown. It will be understood that FIG. 9 also shows the laminate 30 with the second side 46 of the first (or outer) layer 40 visible. As seen in FIG. 9, an outer score line 86 is created on the bottom section 64 of the second side 46 of the first layer 40. The scoring may be performed after the laminate 30 is created but can be performed before, simultaneously with, or after the scoring is performed on the second side 104 of the second (or inner) layer 100. Desirably, the score line 86 is created by laser scoring and, as shown in FIG. 10, can be considered to define an outer smile cut 86. The outer smile cut or outer score line 86 defines an outer smile area 82 with a tongue 84. The scoring is on the polypropylene layer 42 only and does not score beyond the metal layer 122 (i.e., it does not score the second (or inner) layer 100). The depth of the laser cut may be controlled in a manner known by those of skill in the art to provide such precision cutting. The outer smile area 82 is larger than the inner smile area 130 as the score lines are laterally offset to create a marginal region 73. FIG. 10 shows a partial side cross sectional view of the portion of the laminate 30 that has been score cut.

As best appreciated from FIG. 10, first the score line 132 is laterally offset from the second score line 86 to define a marginal region 73 between the first score line 132 and the second score line 86 and to define a surrounding region 63 that extends throughout the laminate 30 outside of the marginal region 73.

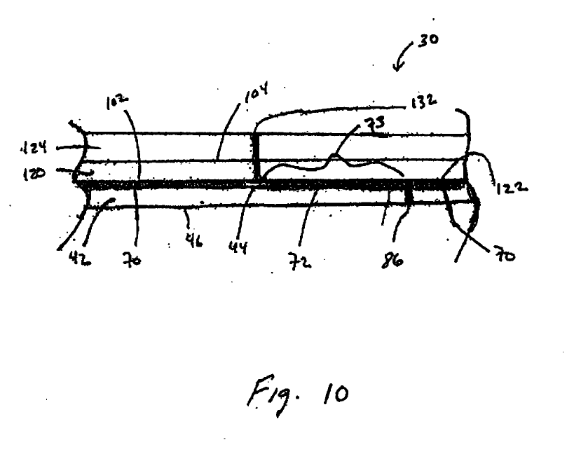

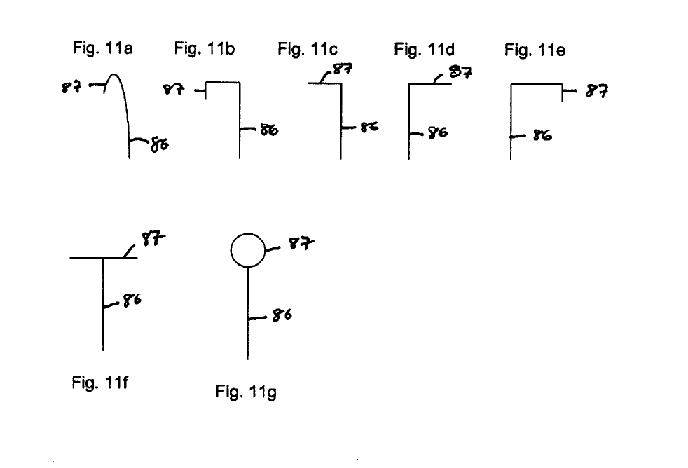

Adjacent the line 60, the second score line 86 has ends 87 that define a discontinuity of the second score line 86. The discontinuity in the ends 87 will hinder further tear propagation as the tongue 84 is lifted and the second score line 86 is torn. In one embodiment as shown in FIG. 9, the discontinuity has a J-shape. It is to be understood; however, that any suitable discontinuous shape may be used so long as it provides a change in direction of the second score line 186, which will result in a hindering of the tear propagation. Accordingly, FIGS. 11a-11g show exemplary shapes that provide a suitable discontinuity.

One surface of the tongue 84 may be printed or patterned with a rubberized or elastomeric material to provide a gripping surface, as best seen in FIG. 3. Providing such a grip surface may also assist the tongue to assume a position where it can be easily grasped by the user. For example, the additional weight caused by the presence of the rubberized or elastomeric material may work to cause the printed surface to lay adjacent the front surface 12 of the package. While a representative pattern of printed material is shown in FIG. 3, it is contemplated that the pattern could take any suitable and desired shape.

After the laminate 30 is formed and score cut, the laminate may be wound to form roll stock (not shown). During the package 10 forming operation, the laminate 30 is unwound from the roll stock. A desired number of the sticks 2 are placed adjacent the second side 104 of the second (or inner) layer 100 and the laminate 30 is folded along the fold line 110. The laminate 30 is folded such that the one section 112 of the second side 104 of the second (or inner) layer 100 is juxtaposed with another section 114 of the second side 104 of the second layer and such that the top section 62 and the bottom section 64 will form the rear 14 and front 12 of the package 10. The laminate 30 is then cut and sealed to create the sides 22, 24, 26 of the package 10. Of course, it is to be understood that these operations could take place in other sequences. For example, the laminate 30 may be unwound and cut, after which the confectionery product is placed adjacent the second side 104 of the second (or inner) layer 100. Thereafter, the laminate 30 is folded along fold line 110, cut, and then sealed to create the sides 22, 24, 26 of the package 10.

Turning back to FIG. 2, the package 10 is shown with the outer smile cut 86 visible on the front 12. With the above in mind, when it is desired to open the package 10, the tongue 84 is lifted or pulled away from the front 12 major surface. Because of the scoring or inner smile cut 132 on the second (or inner) layer 100 and because the metal layer 122 on the second layer 100 is adhered to the first (or outer) layer 40, the inner smile cut 132 of the second (or inner) layer 100 tears together with the outer smile cut 86 on the first (or outer) layer 40. In addition, because the inner smile area 130 is smaller than the outer smile area 82, and because of the prior pattern application of releasable adhesive 72 (as well as the provision of an adhesive-free area 74), an opening panel 80 is defined with releasable adhesive 72 provided adjacent the perimeter 88 of the opening panel. Moreover, the portion of the opening panel 88 that contains the releasable adhesive 72 is in contact with a portion of the metal layer 122 to provide an effective reclosable seal.

Turning now to FIGS. 12a and 12b, another method of making the package 10 is shown. In this embodiment, a first laminate 150 is formed to define a front major surface 152. The first laminate 150 may be formed in the same manner described above in connection with the formation of the laminate 30, except that the laminate will not be folded. Instead, a second material 154 will be used or formed to define a back 156 major surface. The second material 154 may be formed from any suitable material such as polypropylene, polyethylene, laminates, or other materials that can effectively seal with the first laminate 150 to provide a closed package 10 according to the present invention.

The first laminate 150 will be scored in the manner described above to provide an opening panel 80 in the same manner as described above. Thereafter, each of the edges of the first laminate 150 and the second material 154 are sealed to create a closed package 10.

Turning now to FIG. 13, another method of making the package 10 is shown. In this embodiment, a laminate 330 is made in the same manner as described above, except, as seen in FIG. 13, the laminate will have three sections 302, 304, 306 with two fold lines 308, 310. In addition, the first section 302 has a peripheral edge 320 that will join with a peripheral edge 334 provided on the third section 306. To finish the package 10, the first section 302 and the third section 306 are folded away from the outer smile cut 86 and toward each other after the product has been inserted. The peripheral edges 320 and 334 are sealed, such as by heat sealing or other suitable means. Alternatively, a fin seal 350 as shown in FIG. 14a or a lap seal 360 as shown in FIG. 14b may be created at the rear of the package 10. Of course, other known seals may be created as is known to those of skill in the art.

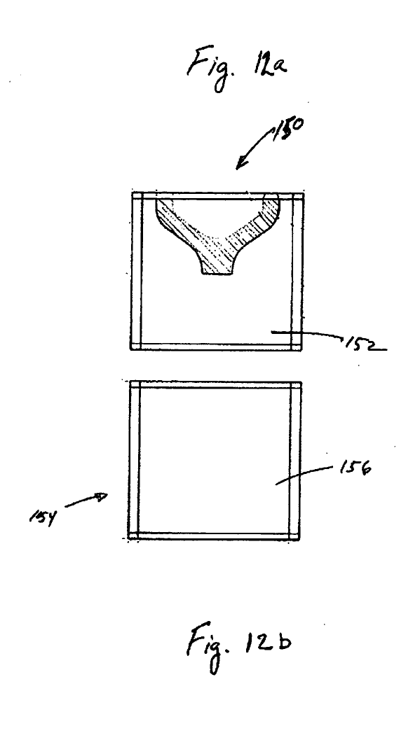

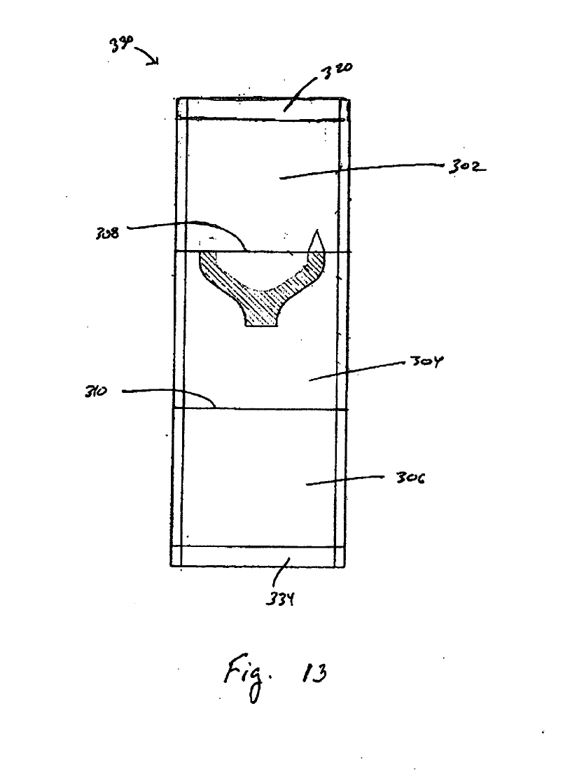

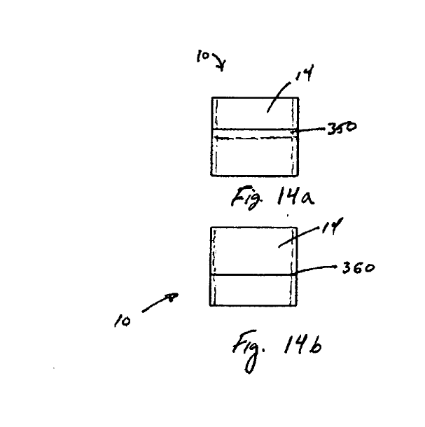

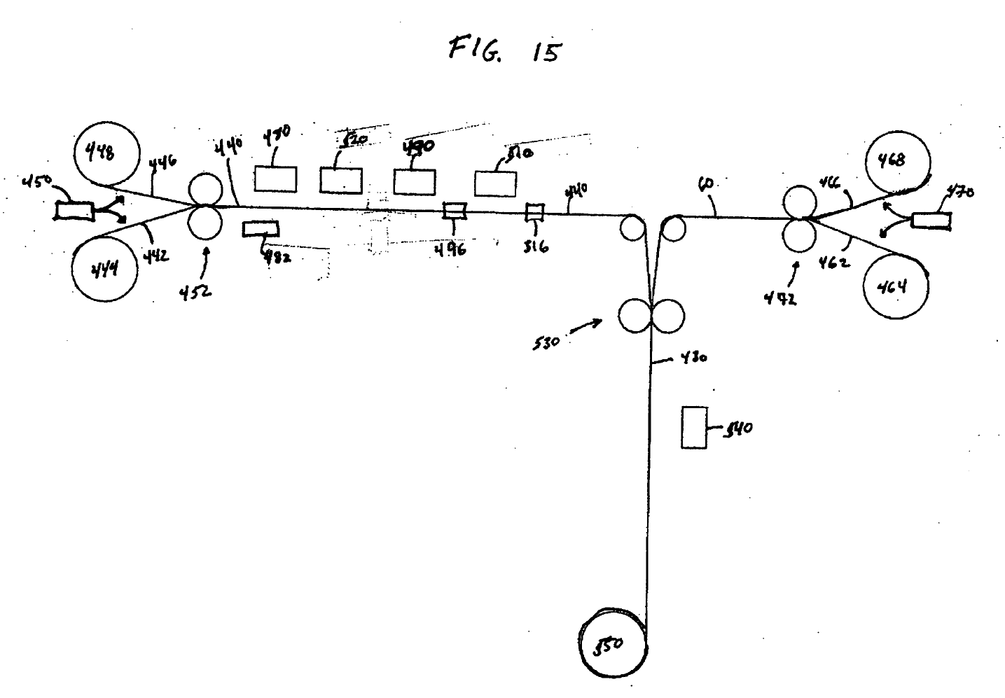

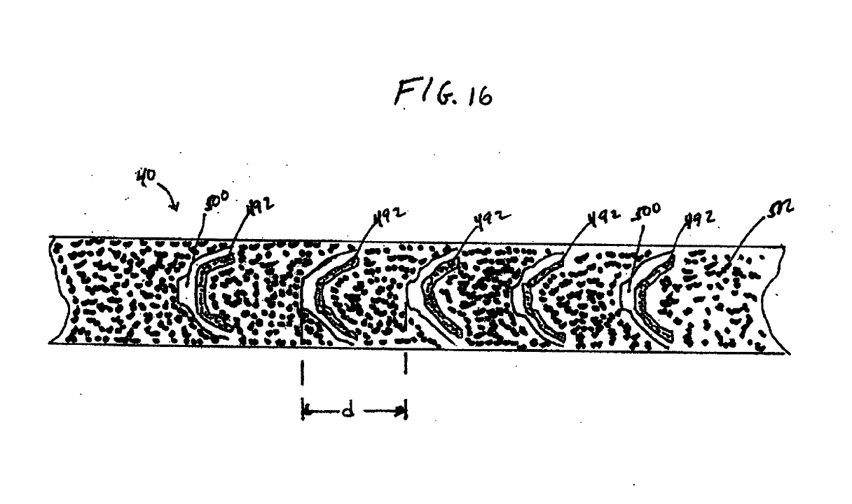

Turning now to FIG. 15, another embodiment of the manufacturing process of the present invention is depicted. A first structure 440 is formed by joining a first layer 442 with a second layer 446. The first layer 442 may be advanced from a supply roll 444 and the second layer 446 may be advanced from a different supply roll 448. Adhesive 450 may be applied to the first layer 442, the second layer 446, or both. Thereafter, the first layer 442 and the second layer 446 may be joined in a laminating station 452 to form the first structure 440.

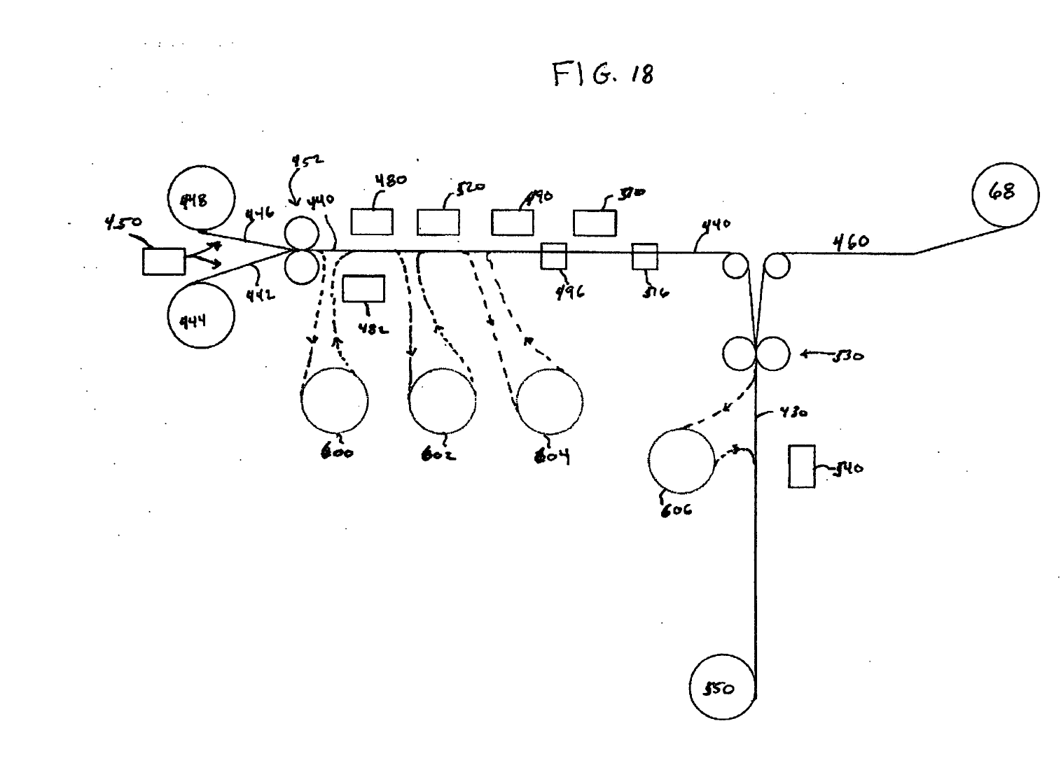

Alternatively, the first structure 440 may be supplied from a roll of preformed first structure laminate 600 (as best seen in FIG. 18). In addition, while FIG. 15 shows the first structure 440 being formed from two film layers, it is contemplated that the first structure 440 could be formed from more than two layers, e.g., from three or more layers. In addition, the formed first structure 440 could be rolled up on a spool 600 for later processing, as described below.

Various materials can be used for the layer(s) of the first structure 440, including polymers such polyesters, polyolefins (including homopolymers and copolymers), polyamides, and others; paper; metal foil; and the like. Advantageously, when metal foil is used as an inner layer, it allows partial scoring through the outer layer while maintaining structural integrity for later operations such as scoring, batch rolling, transporting, batch unrolling, and the like.

The first structure 440 may then be advanced by suitable web driving and handling equipment (not shown) to an optional print station 480 comprising a printing apparatus, such as a rotogravure printer or the like, for printing graphics and/or indicia on the first structure by applying inks to a surface of the first structure 440. In one embodiment of the invention, the first structure 440 includes an outer layer that is substantially transparent and may be reverse-printed in the print station so that the inks will be visible through the first structure 440. The inks may be applied to the surface of the first structure 440 that is subsequently laminated to another structure, as described below; from the opposite side of the first structure, which will form an exterior of a package 10 constructed from the laminate 430 created according to this embodiment.

Prior to printing the first structure 440 at the print station 480, the surface of the first structure 440 to be printed can be treated by a corona discharge or flame treatment apparatus 482 to render the surface more-receptive to the inks and/or to render the surface more-readily bondable to the pressure-sensitive adhesive that is subsequently pattern-applied to the surface as described below.

Following the optional corona/flame treatment and/or optional printing operation, the first structure 440 may be advanced to the next processing stage or it may be rolled up onto a spool 602 (as best seen in FIG. 18) and stored for subsequent processing operations.

The first structure 440 either from the previous processing step or from roll 602 is advanced to a scoring station 520 where a first score line 86 (FIG. 2) is formed through the thickness of the first structure 440. The first score line 86 is in registration with (i.e., coincides with) the printing of the graphics or indicia or other features. The first score line 86 extends substantially through the thickness of the first structure 440.

The first scoring station 520 can comprise a laser. The use of lasers for scoring through flexible materials is generally known, for example as described in U.S. Pat. Nos. 3,909,582 and 5,229,180, the contents of which are incorporated herein by reference. The depth of the score line formed by the laser can be regulated by regulating the power output or beam intensity of the laser beam, the width or spot size of the laser beam, and the amount of time a given spot on the film surface is irradiated by the beam. These factors generally are selected based on the characteristics of the material being scored. Some materials are more readily scored by lasers than other materials, as known in the art.

As noted, the first score line 86 should be in registration with one or more features such as printing, indicia marks, the location of the outer perimeter of the pressure-sensitive strip 492 (and the outer perimeter of the thumb tab 500, if present). To accomplish this registration, the operation of the laser is controlled to be synchronized with the advancement of the first structure. A sensor disposed adjacent the first structure can be used to detect a feature on the first structure (such as printing) whose location in relation to the strip of pressure-sensitive adhesive 492 is known, and the sensor's output signal can be used by a suitable controller (not shown) for controlling the laser. Subsequent to the scoring, the first structure 440 may be rolled onto spool 604 for subsequent processing (as best seen in FIG. 18).

After scoring, the first structure 440 may be advanced (either from spool 604 or from the previous continuous scoring station 520) to a first adhesive application station 490 at which a pressure-sensitive adhesive 492 may be applied to the first structure 440 in a predetermined pattern that recurs at regular intervals along the lengthwise direction of the first structure 440. The predetermined pattern may be in the form of a strip of various forms or shapes. As illustrated, one shape for the strip pattern may be generally U-shaped or smile shaped, for reasons that will become apparent. Other shapes for the pattern can be used. The pattern can include a region that is free of adhesive 500 and that will ultimately form a thumb tab or grasping portion of the first structure 440 as further described below.

The pressure-sensitive adhesive 492 can comprise various compositions. Pressure-sensitive adhesives form viscoelastic bonds that are aggressively and permanently tacky, adhere without the need of more than a finger or hand pressure, and require no activation by water, solvent or heat. Pressure-sensitive adhesives are often based on non-crosslinked rubber adhesives in a latex emulsion or solvent-borne form, or can comprise acrylic and methacrylate adhesives, styrene copolymers (SIS/SBS), and silicones. Acrylic adhesives are known for excellent environmental resistance and fast-setting time when compared with other resin systems. Acrylic pressure-sensitive adhesives often use an acrylate system. Natural rubber, synthetic rubber or elastomer sealants and adhesives can be based on a variety of systems such as silicone, polyurethane, chloroprene, butyl, polybutadiene, isoprene, or neoprene. When the packaging laminate of the invention is to be used for food packaging, the pressure-sensitive adhesive generally must be a food-grade composition. Various pressure-sensitive adhesives are approved by the U.S. Food and Drug Administration for use in direct food contact, as regulated by 21 CFR Part 175.300. Food-grade pressure-sensitive adhesives are preferred for use in the present invention. Additives (e.g., particulates or the like) can be added to the pressure-sensitive adhesive to reduce the tenacity of the bond to the second structure 460, if necessary, so that the pressure-sensitive adhesive 492 readily detaches from the second structure 460 on opening (particularly on the very first opening).

While denoted as a pressure-sensitive adhesive, the use of a cohesive is also contemplated. In this regard, the term “cohesive” refers to a material that is an adhesive that only sticks to a cohesive surface, most commonly to another layer of itself. Cohesives are commercially available from a supplier such as Henkel and the particular cohesive composition is not a feature of the present invention. Typically, the cohesive is applied to the first structure 440. The desired cohesive is such that, although it is applied to the first structure 440, a portion of the cohesive is transferred to the portion of the outer structure 460 juxtaposed with the area on which the cohesive is applied. In addition, the cohesive is formulated such that the bonding affinity between the cohesive and either of the first structure 440 and the second structure 460 is greater than the bonding affinity between the cohesive on each of the first and second structure so that the portions containing the cohesive are is rebondable or reclosable.

The pattern of pressure-sensitive adhesive 492 is applied to the first structure 440 at regular intervals along the first structure 440. The spacing or index distance d between the patterns can correspond to a dimension, such as a length, of packages 10 to be produced from the laminate 430.

The adhesive application station 490 can comprise any suitable device capable of accurately applying the pressure-sensitive adhesive 492 to the first structure 440 in the desired pattern at regular intervals along the first structure 440. For example, the adhesive application station 490 can comprise one or more gravure rolls that pick up the pressure-sensitive adhesive 492 from a reservoir on the outer surface of the roll such that the adhesive fills one or more recessed areas in the surface. A doctor blade may then be used to scrape off excess adhesive so that it remains essentially only in the recessed area(s). The first structure 440 may be contacted by the gravure roll with a backing roll that may be used to provide support on the opposite side of the first structure 440.

After application of the pressure-sensitive adhesive 492, the first structure 440 may be advanced to a dryer 496 such as an oven or the like, to dry the pressure-sensitive adhesive 492. The first structure 440 may then advanced to a second adhesive application station 510 at which a permanent laminating adhesive 512 is applied to the first structure 440 in such a manner that a sufficiently large proportion of the surface is covered by the permanent adhesive 512 to permit the first structure 440 to be adhesively attached to a second structure 460 at a downstream laminating station 530. Alternatively, the first structure 440 may be advanced to the second adhesive application station 510 before being advanced to the dryer 496. Thereafter, the first structure 440, which contains both the pressure-sensitive adhesive 492 and the permanent laminating adhesive 512, is advanced to the dryer 516 to dry the adhesives.

The permanent adhesive 512 does not cover the pressure-sensitive adhesive 492. Furthermore, when the pattern of pressure-sensitive adhesive 492 includes an adhesive-free region 500 (74) to form a thumb tab or grasping portion as previously noted, the pattern of the permanent adhesive 512 also does not cover the adhesive-free region 500 (74). Thus, the permanent adhesive 512 should be applied by an apparatus capable of accurately applying the permanent adhesive 512 in a predetermined pattern, in registration with the pressure-sensitive adhesive 492 but not covering it or the adhesive-free region 500 (74), if present. A suitable adhesive application device can be a gravure roll of the type previously described.

The permanent adhesive 512 can comprise various compositions. Suitable examples include two-component polyurethane adhesive systems, such as Tycel 7900/7283 available from Henkel.

While FIG. 15 depicts a certain order of processing of the first structure 440, it is contemplated that the various processing steps can be varied according to manufacturing and processing desires. Thus, for example, it may be desirable to apply adhesives prior to scoring.

After application of the adhesives and any optional drying, the first structure 440 is advanced to a laminating station 530 that can include a pair of rolls forming a nip therebetween. The first structure 440 is passed through the nip along with a second structure 460 that is separately advanced, and the first structure 440 is laminated to the second structure 460.

As noted above, the second structure 460 is advanced separately from the first structure 440 to the laminating station 530. The second structure 460 may be formed from one or more layers. The second structure 460 may be coextensive with the first structure 440, i.e., the width of the second structure 460 may be substantially equal to the width of the first structure 440 and the longitudinal edges of the second structure 460 substantially coincide with the longitudinal edges of the first structure 440.

As shown in FIG. 15, the second structure 460 may be formed from two layers. Accordingly, the second structure 460 is formed by joining a first layer 462 with a second layer 466. The first layer 462 may be advanced from a supply roll 464 and the second layer 466 may be advanced from a different supply roll 468. Adhesive 470 may be applied to the first layer 462, the second layer 466, or both. Thereafter, the first layer 462 and the second layer 466 may be joined in a laminating station 472 to form the second structure 460.

Alternatively, the second structure 460 may be supplied from a roll of preformed second structure laminate. In addition, while FIG. 15 shows the second structure 460 being formed from two film layers, it is contemplated that the second structure 460 could be formed from more than two layers, e.g., from three or more layers.

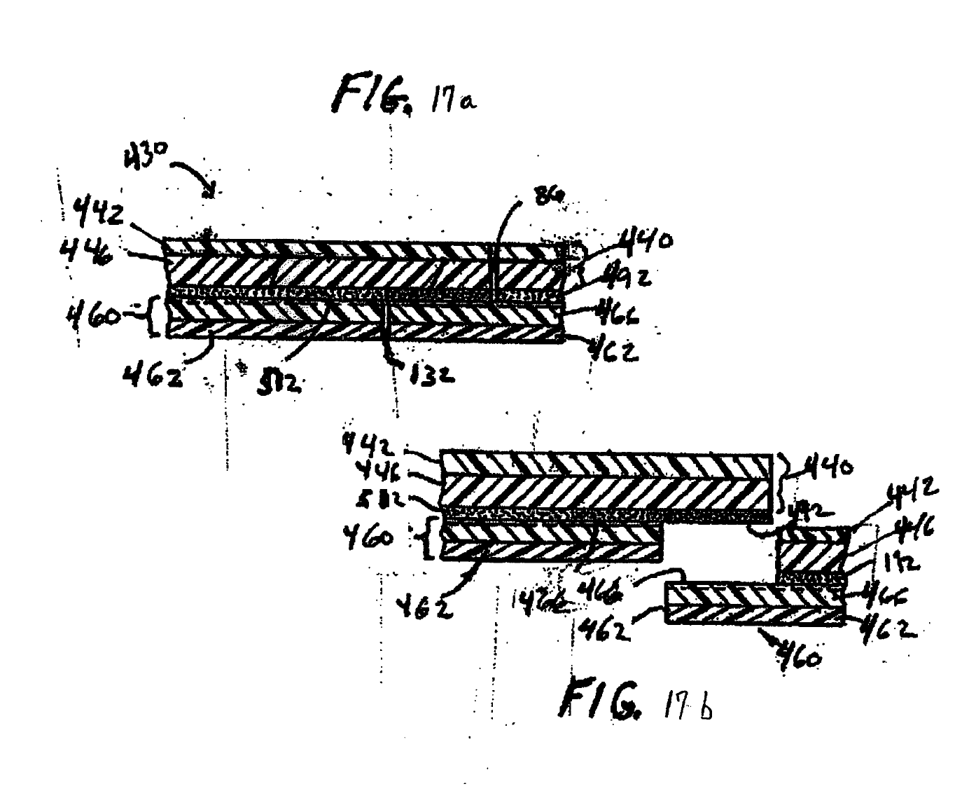

After the laminate 430 is formed, the laminate 430 may be rolled up on roll 606 for storage and later processing as shown in FIG. 18. Alternatively, as shown in FIG. 15, the laminate 430 is advanced to a second scoring station 540 at which a second score line 542 is formed through the thickness of the second structure 460. The second score line 542 is in registration with (i.e., coincides with) the inner perimeter of the strip-shaped pattern of pressure-sensitive adhesive 492. The second score line 542 extends substantially through the thickness of the second structure 460, but preferably does not extend to any substantial extent into the first structure 440, as illustrated in FIG. 17a, 17b.

The second scoring station 540 can comprise a laser. The operation of the laser is synchronized with the advancement of the laminate 430. A sensor can detect a feature, such as an eye mark or printing, on the laminate 430 whose location in relation to the pressure-sensitive adhesive strip 492 is known, and the sensor output can be used for regulating the laser operation so that the second score line 542 is in registration with the inner perimeter of the pressure-sensitive adhesive strip 492.

As an alternative to the use of lasers for scoring the laminate, the score lines can be formed by mechanical scoring or cutting. For instance, the first scoring station 520 can comprise a kiss roll and backing roll that form a nip through which the first structure is passed. The kiss roll may include a rotary cutting die defining a cutting edge (not shown). The kiss roll acts in conjunction with the backing roll to cut partially through the thickness of the first structure 440 starting from the outer surface of the first structure, such that the first structure 440 is substantially scored through. The second scoring station 540 may likewise comprise a kiss roll and backing roll for scoring through the second structure 460. The kiss roll acts in conjunction with the backing roll to cut partially through the thickness of the second structure 460 starting from the outer surface of the second structure 460, such that the second structure 460 is substantially scored through while the first structure 440 is left intact.

Additionally, it is within the scope of the invention to laser-score one of the first structure or the second structure and to kiss cut or otherwise mechanically scores the other. This can be advantageous, for example, when one of the structures making up the laminate 430 is readily scored by a laser but the other structure is not. For instance, when the first structure 440 is a polyester such as PET, it can readily be scored with a laser, but if a polyethylene heat seal layer is employed on the second structure 460, laser scoring may not be the best choice because polyethylene does not score well with a laser. In this case, kiss cutting or other mechanical scoring can be used to score the second structure 460.

It is also within the scope of the present invention to conduct the each of the scoring operations after the laminate 430 has been formed. For example, the first scoring station 520 may be adjacent, opposite, or near the second scoring station 540 so that each of the first and second scoring operations take place either simultaneously or relatively soon after each other.

After the scoring operation, the laminate 430 can be sent to a reel-up or take up roll 550 and wound into a roll for subsequent processing. Alternatively, it is possible for the reel-up operation to be omitted, such that the laminate 430 is directly advanced to a fill and seal station.

The laminate 430 can also be slit into a plurality of partial widths and wound into multiple rolls. In this latter instance, each partial width would have the recurring patterns of pressure-sensitive and permanent adhesives applied with suitably configured adhesive applicators to the full-width material, and would have the recurring score lines formed by suitably configured scoring devices acting on either the full-width laminate prior to slitting or acting on each partial-width portion after slitting.

FIG. 2 shows a flexible package 10 in a closed position made according to the process described above. The package 10 includes an outer portion that envelopes the package contents and is sealed to enclose the contents. The outer portion comprises a laminate 430 made by a method in accordance with the invention, such as the laminate previously described. The outer portion is manipulated and sealed along seal lines.

In the illustrated package, the score lines 86, 132 are provided to be on a front surface 12 of the package 10. The area of the package 10 bounded by the score lines can constitute any fraction of the total front surface of the package, but advantageously the area is a majority of the total surface area of front surface 12.

Based on the previous description of the laminate 430 and its formation process, it will be appreciated that the presence of the score lines has little or no impact on the barrier function of the package 10 because each score line 86, 132 extends only partially through the total thickness and the score lines are not aligned with each other. Additionally, the pressure-sensitive adhesive 492 fills the space between the score lines so that even if the score lines overlap somewhat in the thickness direction, there is still no open route between them. Furthermore, the score lines typically have a small width, on the order of a few thousandths of an inch.

Various materials can be used for the construction of the package 10. As noted above, the first structure 440 that forms the outer surface of the package 10 may comprise a single layer of flexible material or several layers of various materials. One material is a polyester such as polyethylene terephthalate (PET). As noted, the PET layer can be reverse-printed if desired, although alternatively it can be printed on its exterior and covered by an over-lacquer (not shown). The second structure 460 forming the inner surface of the package 10 may comprise a barrier layer and a sealant layer. The sealant layer constitutes the innermost surface of and can comprise various sealant materials such as heat seals or cold seals. Heat seals generally are preferred because they provide stronger seals than cold seals typically are capable of achieving. Any suitable heat seal material can be employed, such as polyethylene, polypropylene, ionomer resins such as SURLYN®, or others.

The barrier layer can comprise any of various barrier materials including barrier polymer films such as: ethylene vinyl alcohol copolymer (EVOH), polyamide, and the like; metallized polyolefin films such as polyethylene, polypropylene, oriented polypropylene, and the like; AlOx-coated polymer films; SiOx-coated polymer films; metal foil; and others. The barrier layer and sealant layer can be joined in various ways, including adhesive lamination, extrusion lamination, or coextrusion.

The laminate 430 may also include a metallization layer or a metal foil layer between the first structure 440 and the second structure 460, for example by providing a metallization layer on the surface that faces the first structure 440. This is beneficial in enhancing the barrier performance of the laminate 430. The metallization layer or metal foil layer can also be helpful when a laser is used for scoring the second structure 460. In particular, when the sealant layer comprises polyethylene, which is not as readily scored by laser as some other materials, such as polyester, it can be difficult to employ a sufficiently high laser energy to score through the polyethylene sealant layer without scoring through the laminate 430 more deeply than desired. In particular, it is undesirable to score the entire thickness of the laminate. The metallization layer or metal foil layer can be helpful in “tuning” the laser to penetrate only up to the metallization layer or foil layer.

The function of the opening panel provided by the pattern-applied adhesives and the score lines is described with respect to FIGS. 1 and 2. The package 10 is shown in a closed condition (FIG. 2), for example as initially filled and sealed in a packaging plant. The package 10 has sides 22, 24, 26, that are sealed to each other with one side 20 that may be formed by folding the laminate 430 on itself. On the front 12, the first or outer structure is adhesively joined to the second or inner structure via the permanent adhesive. The outer score line 86 bounds an outer opening portion of the outer structure. In this embodiment, the outer opening portion has a generally U-shaped or smile shaped perimeter having three sides defined by the score line 86, and is attached to the remainder of the outer wrapper along a fourth side (i.e., an imaginary line extending between the free ends of the two legs of the U-shaped score line). The inner score line 132 is also generally U-shaped or smile shaped with its portions parallel to adjacent portions of the outer score line 86, but is spaced inwardly of the outer score line 86 so as to define an inner opening portion of smaller area than the outer opening portion. Accordingly, there is a marginal region of the outer opening portion that extends beyond the edge of the inner opening portion. The pressure-sensitive adhesive 72, 492 is disposed between this marginal region and an underlying surface of the inner structure. The outer opening portion and inner opening portion are permanently joined by the permanent adhesive.

Consequently, when the outer opening portion is detached from the outer wrapper along the outer score line 86 and is peeled back as depicted in FIG. 1, the inner opening portion remains affixed to the outer opening portion and comes with it, thereby creating an opening in the front surface 12 as defined by the inner score line 132. The outer and inner opening portions essentially form a panel 80 that remains attached along a hinge line defined between the free ends of the two legs of the U-shaped score lines.

In one embodiment, the outer structure has a greater affinity for bonding with the pressure-sensitive adhesive 72, 492 than does the surface of the inner structure, and hence the pressure-sensitive adhesive 72, 492 is detached from the surface and remains attached to the marginal region of the outer opening portion. The package 10 is reclosable by re-attaching the pressure-sensitive adhesive 72, 492 to the surface of the inner structure to restore the package 10 to the condition shown in FIG. 2.

The greater bonding affinity of the outer structure can be achieved in various ways. When the outer structure comprises a layer of PET and the layer of the inner structure to which the pressure-sensitive adhesive 72, 492 is attached comprises a polyolefin such as polypropylene, oriented polypropylene, or metallized oriented polypropylene, the PET will naturally have a greater affinity for bonding to the adhesive than will the polyolefin layer. Additionally or alternatively, the surface of the outer structure can be treated, as previously noted, by corona discharge or flame treatment, to increase the surface energy and enhance the bonding affinity. It is also possible, as already noted, to control the bond strength of the pressure-sensitive adhesive to the layer by including an additive in the adhesive to reduce the bond strength, if desired.

Although the pressure-sensitive adhesive 72, 492 may be applied to the outer structure and may remain on the outer structure upon opening, it is also within the scope of the invention to apply the pressure-sensitive adhesive to the inner structure and to remain on the inner structure upon opening.

In another embodiment, particularly where a cohesive is used, a portion of the cohesive is transferred from the surface to which it was initially applied to the other surface and because the cohesive is formulated in a desired manner, the marginal region containing the cohesive is rebondable and reclosable. A cohesive may be desired since it does not exhibit adhesive properties to structures that do not also contain a cohesive. Thus, during processing or use, undesired material will not stick to those areas containing the cohesive; yet, those areas containing the cohesive will readily stick to each other.

It should be noted that the terms “line of weakness” and “score line” as used herein refer either to a complete cutting through of one or more layers of the laminate or to a weakening of such layer(s) allowing the layer(s) to be severed along the score line.

Referring back to FIG. 1, the package 10 of the present invention is shown with the opening panel 80 in an open position to expose the contents of the package 10. The package 10 includes an opposed front 12 and rear of which only the front is shown, an opposed first side 20 and second side 22, and opposed third and fourth sides 24, 26. The front 12 and first side 20 are scored to define an opening panel 80 that can be opened to expose the contents stored within the package 10. It will be appreciated that when the opening panel 80 is in an open position, that a portion of the front 12 and first side 20 of the package are opened or exposed. Put another way, when the opening panel is in an open position, more than a single surface is opened or exposed.

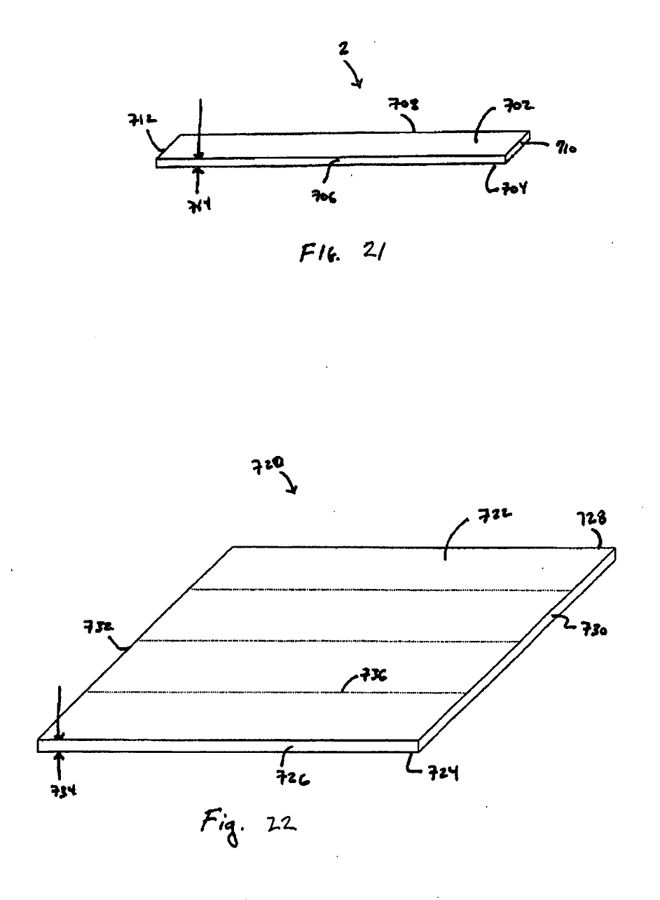

The package of the present invention is shown as containing sticks of gum 2, 4. It is to be understood, however, that the use of the package 10 is not limited to gum but also includes other confectionery products. Therefore, as is known and shown in FIG. 21, a gum stick 2 may be elongate rectangular shaped member having a first face 702, a second face 704 opposite the first face, a first end 710 and a second end 712 opposite the first end, and a third end 706 with a fourth end 708 opposite the third end. The gum stick also has a thickness 714. Specifically, the thickness is substantially smaller than the width (the distance between 706 and 708), which itself is substantially smaller than the length (the distance between 710 and 712). In other words, [L>W>T].

Referring back to FIG. 1, the individual product package 10 will contain one or more sticks of gum 2. As shown in FIG. 1, the sticks of gum 2 are oriented so that one of the first face 702 and second face 704 and one of the first end 710 and second end 712 of the stick of gum 2 is exposed when the opening panel 80 is in an open orientation. In this orientation, one of the first face 702 and second face 704 of the stick of gum 2 are juxtaposed with one of the inner front surface 16 or inner back surface 18. Also, it will be appreciated that a plane of one of the first end 710 and second end 712 is parallel with a plane of one of the first side 20 and second side 22 of the package 10.

Referring to FIG. 3, the sticks of gum 2 may be oriented so that one of the third end 706 and fourth end 708 and one of the first face 702 and second face 704 of the stick of gum 2 are exposed when the opening panel 80 is in an open orientation. In this orientation, one of the first face 702 and second face 704 of the stick of gum 2 is juxtaposed with one of the inner front surface 16 or inner rear surface 18. Also, it will be appreciated that a plane of one of the third end 706 or fourth end 708 is parallel to a plane defined by first side 20 and second side 22 of the package 10 and that a plane of one of the first face 702 and the second face 704 is parallel to the a plane of one of the front surface 12 or the inner rear surface 18 of the package.

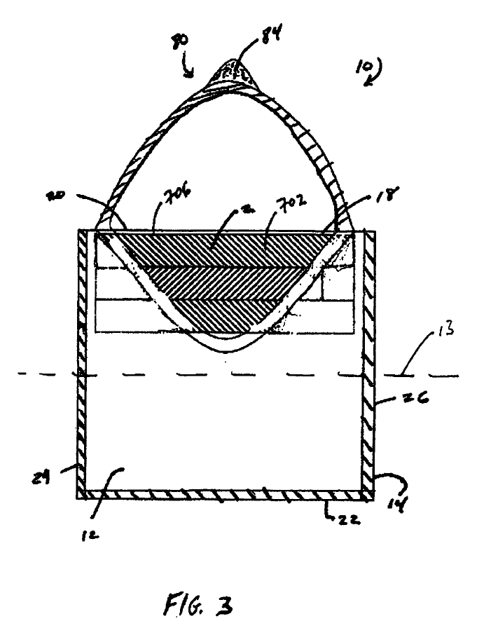

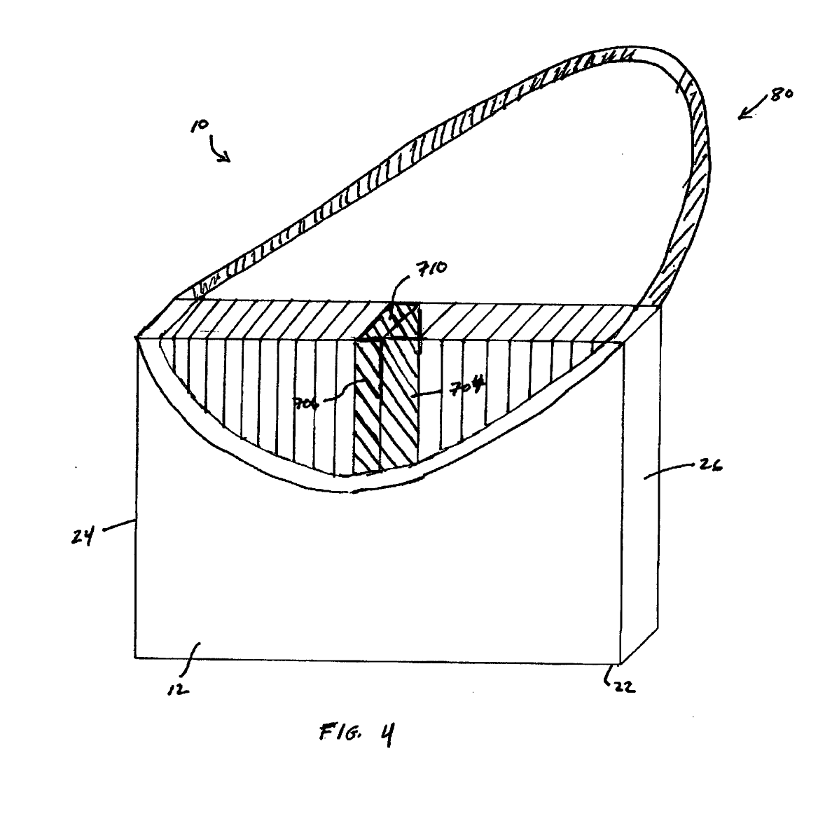

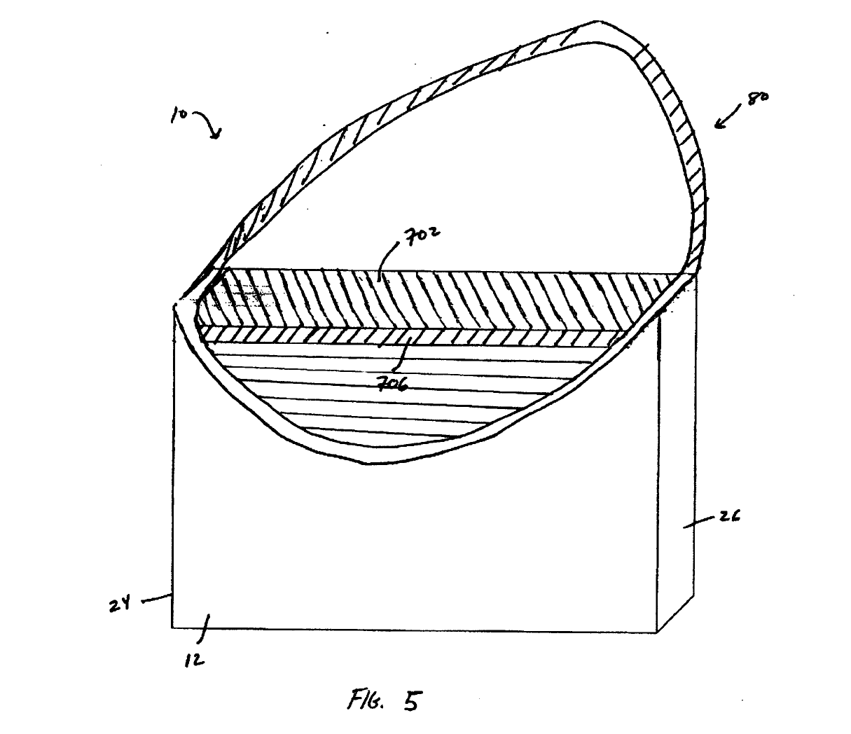

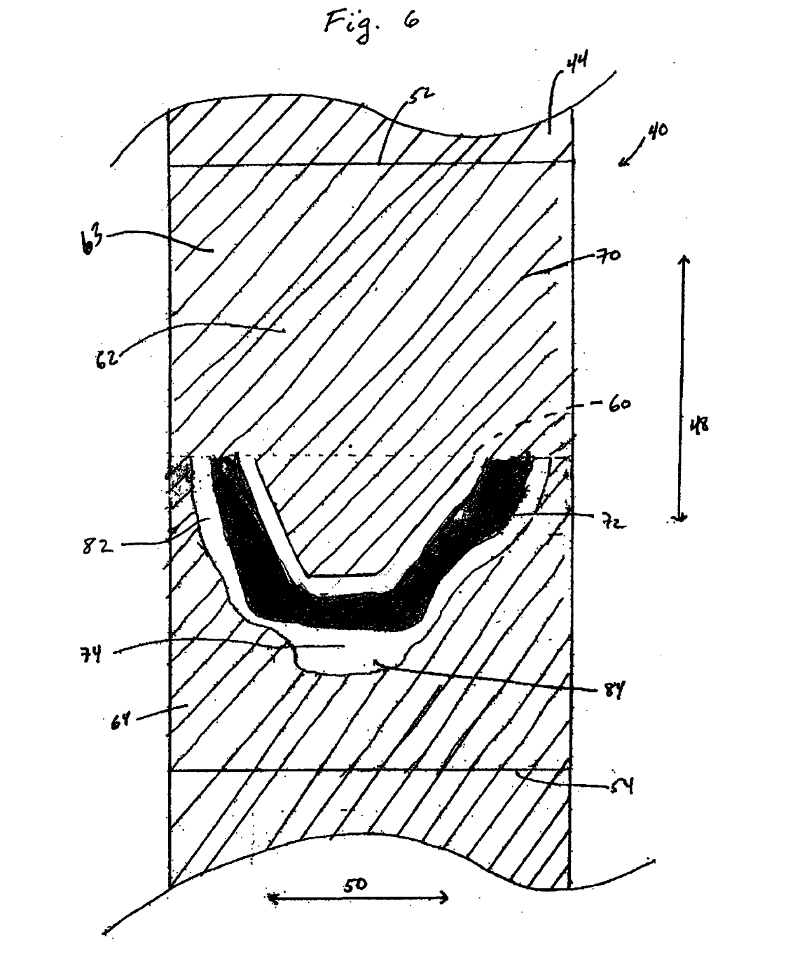

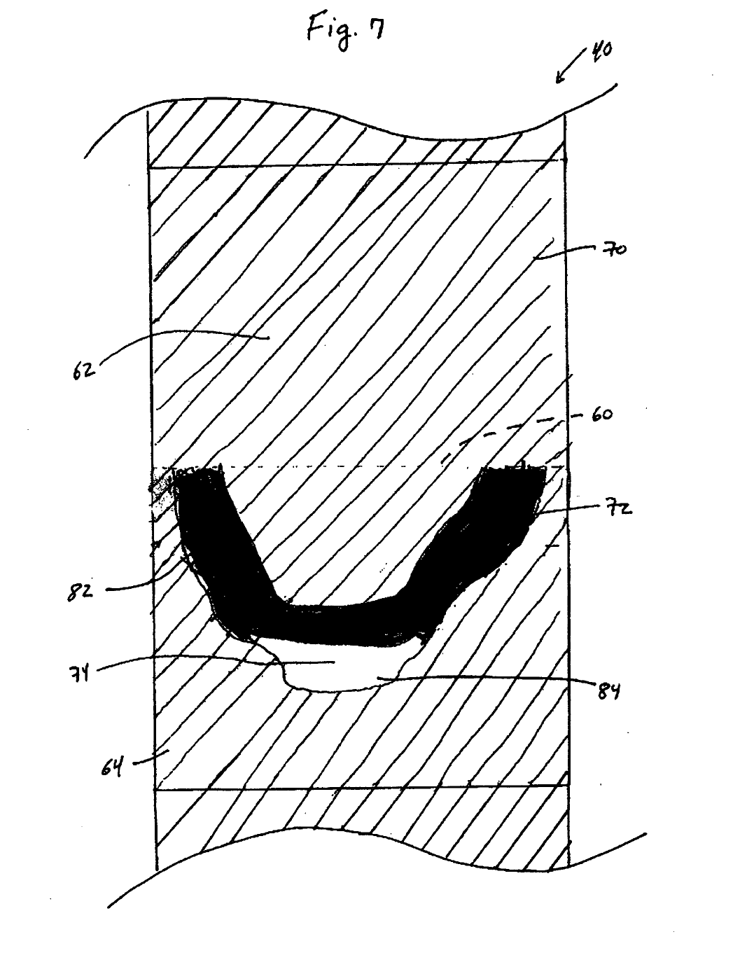

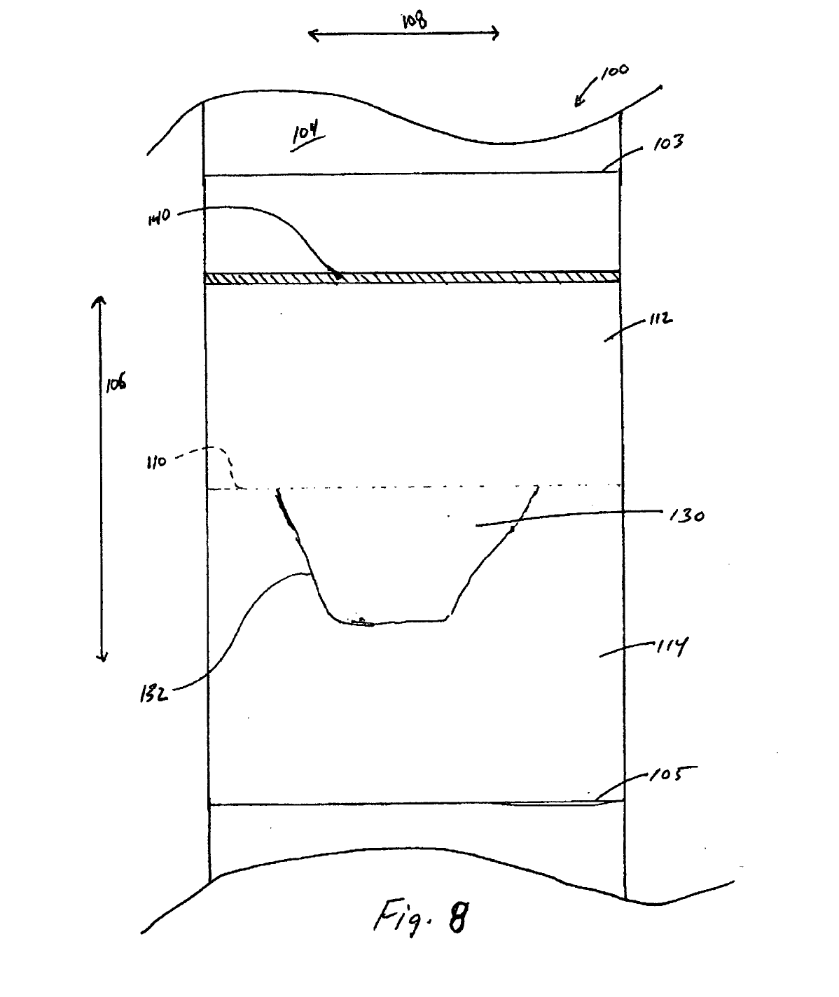

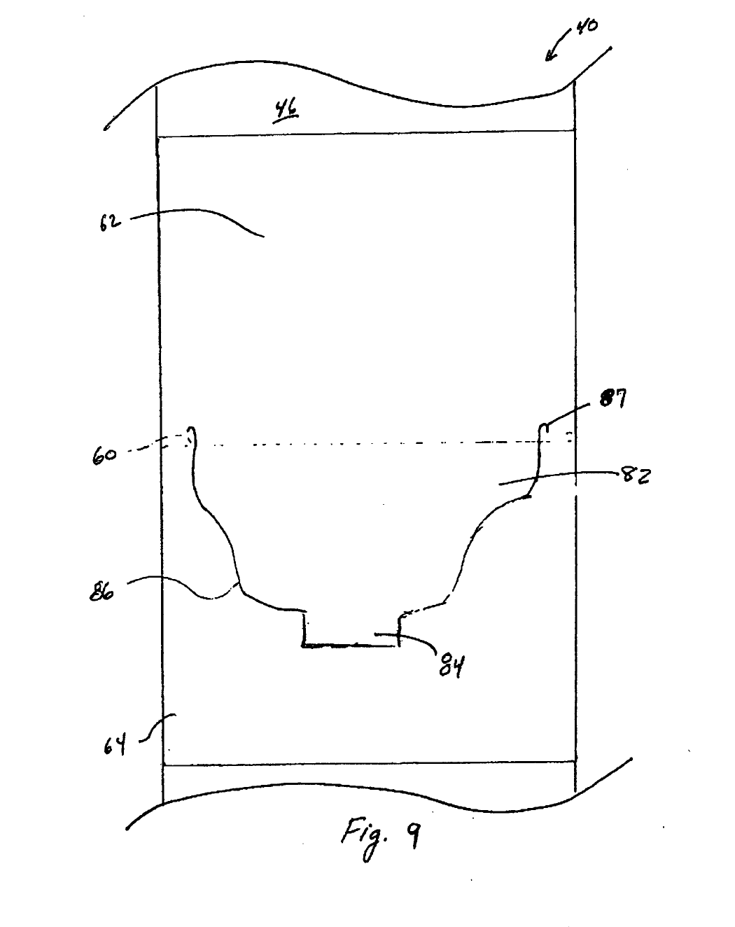

Referring to FIG. 4, the sticks of gum 2 may be oriented so that one of the third end 706 and the fourth end 708 and one of the first end 710 and the second end 712 of the stick of gum 2 is exposed when the opening panel 80 is in an open orientation. In this orientation, one of the third end 706 and the fourth end 708 of the gum is juxtaposed with one of the inner front surface 16 or inner back surface 18. Also, it will be appreciated that a plane of one of the first end 710 and second end 712 is parallel with a plane of one of the first side 20 and second side 22 of the package 10 and that a plane of one of the third end 706 and the fourth end 708 is parallel to the a plane of one of the front surface 12 or the inner rear surface 18 of the package.

Referring to FIG. 5, the sticks of gum 2 may be oriented so that one of the first face 702 and second face 704 of the stick of gum 2 and one of the third end 706 and fourth end 708 of the stick of gum 2 are exposed when the opening panel 80 is in an open orientation. In this orientation, one of the third end 706 and the fourth end 708 of the gum is juxtaposed with one of the inner front surface 16 or inner back surface 18. Also, it will be appreciated that a plane of one of the first face 702 and second face 704 is parallel with a plane of one of the first side 20 and second side 22 of the package 10 and that a plane of one of the third end 706 and the fourth end 708 is parallel to the a plane of one of the front surface 12 or the inner rear surface 18 of the package.

Advantageously, in some of these orientations, when the package 10 is opened, most or all sticks are exposed for easy removal. In addition, another advantage to the package 10 of the present invention is that the package 10 is capable of being folded after one or more of the products 2 have been removed. In this regard, a fold line 13 is shown in FIGS. 1 and 3. The fold line 13 will typically be parallel to a plane defined by one of a third end 706 and a fourth end 708. By orienting the fold line 13 in this manner, it will be easier to reduce the size of the package 10 while retaining the functionality of the reclose feature without mutilating the remaining product or the package itself. Referring to FIG. 1, it will be appreciated that the package 10 can be folded along fold line 13 so that the left side portion is folded over to contact the right side of the package. Furthermore, it will be possible to make additional folds in the package parallel to the illustrated fold line 13 as additional sticks are removed, thus further reducing the side of the package for easier and more compact carriage, for example, in a pocket or purse.

Turning back to FIG. 22, an alternative form of a gum product that can be usefully stored and dispensed from the individual product package 10 according to the present invention is shown. In this alternative form, the gum is in the form of a slab 720 that is shaped and sized to be complementary to the shape and size of the product package 10, for example, generally rectangular. The slab may have a first face 722, a second face 724 opposite the first face 722, a first end 730 and a second end 732 opposite the first end 730, a third end 726 and fourth end 728 opposite the third end 726. The slab 720 also has a thickness 734. Specifically, the thickness is substantially smaller than the width (the distance between 726 and 728) and the length (the distance between 730 and 732). The slab 720 may be provided with at least one and desirably more than one score line 736, which will allow the consumer to easily break a portion of the slab from the remaining portion along the score line 736. The slab 720 is desirably oriented within the package 10 such that the third end 726 or fourth end 728 is parallel to the plane defining the opening of the package 10. In other words, the third end 726 or fourth end 728 is parallel to the plane defined by the first side 20 of the package. Put another way, the slab 720 is oriented such that one or both of the first end 710 and the second end 712 are in a plane substantially perpendicular to the opening or a plane defined by the first side 20 of the package. Desirably, when provided, the score line 736 or lines 736 are oriented such that they are parallel to the plane defining the opening of the package or by the first side 20 of the package. Put yet another way, the first face 722 of the slab is juxtaposed with one of the inner front surface 16 or inner back surface 18 of the package 10. Likewise, the second side of the slab 724 is juxtaposed with one of the inner front surface 16 or inner back surface 18 of the package 10.

While it is contemplated that a single package 10 may be sold or otherwise provided to a consumer, it is also contemplated that two or more individual packages 10 may be bundled together in a suitable fashion. For example, two or more individual packages may be wrapped with suitable wrapping to provide a multiplicity of individual packages. It is also contemplated to provide a container 800, as shown in

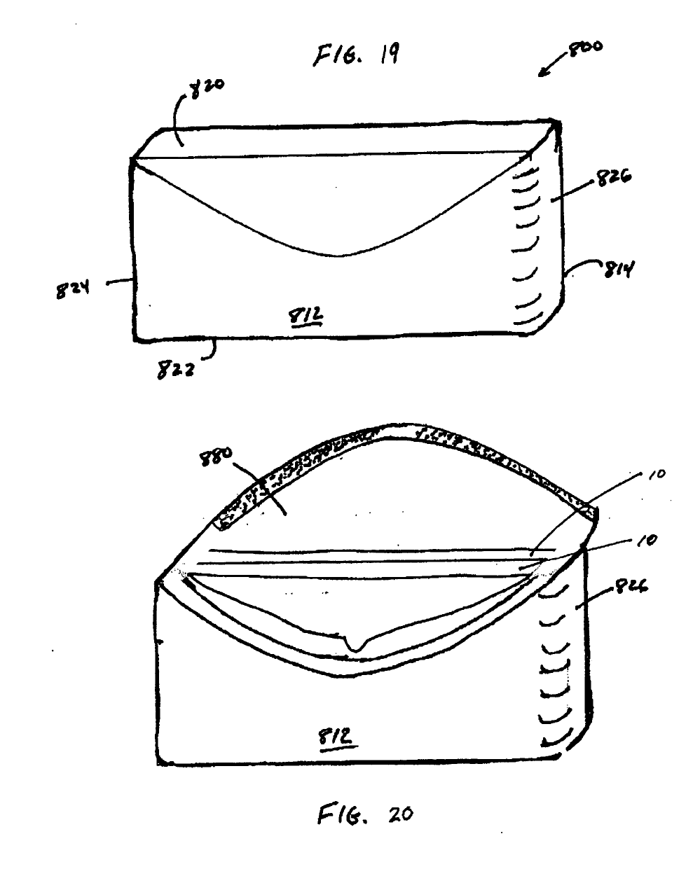

FIGS. 19 and 20, which can be made using the same material described above for the packages 10 and can be made by any of the processes described above and which can resealably store and contain two or more individual product packages 10. The container 800 may be similar to the package 10 described above except that it will be wider, i.e., configured such that the distance between its front 812 and rear 814 is can be greater that the distance between the front 12 and 14 rear of the individual package 10 so that two or more individual packages 10 can be stored within the container 800.

Inasmuch as the container 800 shares common characteristics of the flexible package 10 described above, such as the panel, the scoring, the releasable adhesive, etc., one of skill in the art will appreciate the container 800 without a detailed description of such. Suffice to say, the container 800 includes a front 812, a rear 814 opposite the front, a top 820, a bottom 822, opposite the top, a first side 824 and a second side 826 opposite the first side. A panel 880 is provided monolithically with the rear 814 and is configured to fold over and resealably join to the front 812, in a manner similar to that described above for the individual package. Advantageously, because the container 800 may be constructed of flexible material, when an individual package 10 is removed from the container, the size of the container 800 can be reduced by, for example pushing the front 812 toward the rear 814.

Alternatively, a similar container may be constructed from any conventional design utilizing flexible materials as previously described or rigid materials such as paperboard, plastic and metal.

The foregoing detailed description has described only a few of the many forms that this invention can take. For this reason, this detailed description is intended by way of illustration, and not by way of limitation. It is only the following claims, including all equivalents that are intended to define the scope of this invention.

1. A reclosable package for confectionery products comprising:
a. a laminated sheet comprising an inner layer and an outer layer wherein the inner layer is oriented toward the inside of the package and the outer layer is oriented toward the outside of the package;
b. a first score line extending at least substantially into the inner layer but not extending into the outer layer;
c. a second score line extending at least substantially into the outer layer but not extending into the inner layer and being laterally offset from the first score line to define an opening panel in the package and a marginal region between the first and second score lines and to define a surrounding region of the sheet outside of the marginal region; and,
d. a plurality of confectionery products, each having a first end and an opposed second end to define a length, a third end and an opposed fourth end to define a width, and a first face and an opposed second face to define a thickness;
wherein the length is greater than the width and the width is greater than the thickness; wherein when the opening panel is in a closed position, the confectionery products are retained within the package and the confectionery products are oriented such that one of the first face and the second face of at least one of the plurality of confectionery products and one of the first end and the second end of at least one of the plurality of confectionery products are exposed when the opening panel is an opened position.

2. The package of claim 1 further comprising a releasable adhesive disposed between the inner and outer layers in the marginal region and a laminating adhesive disposed between the inner and outer layers and extending substantially throughout the surrounding region.

3. The package of claim 2 wherein a portion of the marginal region is free of releasable adhesive.

4. The package of claim 1 wherein the package includes an opposed front and rear, opposed first and second sides, and opposed third and fourth sides and wherein the opening panel is effective to open at least a portion of the front and first side of the package.

5. The package of claim 1 wherein the confectionery products are chewing gum.

6. The package of claim 4 wherein the first end of the plurality of confectionery products has a plane that is parallel to the plane of the first side of the package.

7. A reclosable package for confectionery products comprising:
a. a laminated sheet comprising an inner layer and an outer layer wherein the inner layer is oriented toward the inside of the package and the outer layer is oriented toward the outside of the package;
b. a first score line extending at least substantially into the inner layer but not extending into the outer layer;
c. a second score line extending at least substantially into the outer layer but not extending into the inner layer and being laterally offset from the first score line to define an opening panel in the package and a marginal region between the first and second score lines and to define a surrounding region of the sheet outside of the marginal region; and,
d. a plurality of confectionery products, each having a first end and an opposed second end to define a length, a third end and an opposed fourth end to define a width, and a first face and an opposed second face to define a thickness;
wherein the length is greater than the width and the width is greater than the thickness; wherein when the opening panel is in a closed position, the confectionery products are retained within the package and the confectionery products are oriented within the package such that one of the third end and the fourth end of at least one of the plurality of confectionery products and one of the first face and the second face of at least one of the plurality of confectionery products are exposed when the opening panel is in an opened position.

8. The package of claim 7 further comprising a releasable adhesive disposed between the inner and outer layers in the marginal region and a laminating adhesive disposed between the inner and outer layers and extending substantially throughout the surrounding region.

9. The package of claim 8 wherein a portion of the marginal region is free of releasable adhesive.

10. The package of claim 7 wherein the package includes an opposed front and rear, opposed first and second sides, and opposed third and fourth sides and wherein the opening panel is effective to open at least a portion of the front and first side of the package.

11. The package of claim 10 wherein the third end of the plurality of confectionery products has a plane that is parallel to a plane of the first side of the package.

12. The package of claim 7 wherein the confectionery products are chewing gum.

13. A reclosable package for confectionery products comprising:
a. a laminated sheet comprising an inner layer and an outer layer wherein the inner layer is oriented toward the inside of the package and the outer layer is oriented toward the outside of the package;
b. a first score line extending at least substantially into the inner layer but not extending into the outer layer;
c. a second score line extending at least substantially into the outer layer but not extending into the inner layer and being laterally offset from the first score line to define an opening panel in the package and a marginal region between the first and second score lines and to define a surrounding region of the sheet outside of the marginal region; and,
d. a plurality of confectionery products, each having a first end and an opposed second end to define a length, a third end and an opposed fourth end to define a width, and a first face and an opposed second face to define a thickness;
wherein the length is greater than the width and the width is greater than the thickness; wherein when the opening panel is in a closed position, the confectionery products are retained within the package and the confectionery products are oriented within the package such that one of the first end and the second end of at least one of the plurality of confectionery products and one of the third end and the fourth end of at least one of the plurality of confectionery products are exposed when the opening panel is in an opened position.

14. The package of claim 13 further comprising a releasable adhesive disposed between the inner and outer layers in the marginal region and a laminating adhesive disposed between the inner and outer layers and extending substantially throughout the surrounding region.

15. The package of claim 14 wherein a portion of the marginal region is free of releasable adhesive.

16. The package of claim 13 wherein the package includes an opposed front and rear, opposed first and second sides, and opposed third and fourth sides and wherein the opening panel is effective to open at least a portion of the front and first side of the package.

17. The package of claim 13 wherein the confectionery products are chewing gum.

18. The package of claim 16 wherein the first end of the plurality of confectionery products has a plane that is parallel to a plane of the first side of the package.

19. A reclosable package for confectionery and gum products comprising:
a. a laminated sheet comprising an inner layer and an outer layer wherein the inner layer is oriented toward the inside of the package and the outer layer is oriented toward the outside of the package;
b. a first score line extending at least substantially into the inner layer but not extending into the outer layer;
c. a second score line extending at least substantially into the outer layer but not extending into the inner layer and being laterally offset from the first score line to define an opening panel in the package and a marginal region between the first and second score lines and to define a surrounding region of the sheet outside of the marginal region; and,
d. a plurality of confectionery products, each having a first end and an opposed second end to define a length, a third end and an opposed fourth end to define a width, and a first face and an opposed second face to define a thickness;
wherein the length is greater than the width and the width is greater than the thickness; wherein when the opening panel is in a closed position, the confectionery products are retained within the package and the confectionery products are oriented within the package such that one of the first face and the second face of at least one of the plurality of confectionery products and one of the third end and the fourth end of at least one of the plurality of confectionery products are exposed when the opening panel is in an opened position.

20. The package of claim 19 further comprising a releasable adhesive disposed between the inner and outer layers in the marginal region and a laminating adhesive disposed between the inner and outer layers and extending substantially throughout the surrounding region.

21. The package of claim 20 wherein a portion of the marginal region is free of releasable adhesive.

22. The package of claim 19 wherein the package includes an opposed front and rear, opposed first and second sides, and opposed third and fourth sides and wherein the opening panel is effective to open at least a portion of the front and first side of the package.

23. The package of claim 19 wherein the confectionery products are chewing gum.

24. The package of claim 22 wherein the first face of the plurality of confectionery products has a plane that is parallel to a plane of the first face of the package.

25. A reclosable package for confectionery products comprising:
a. a laminated sheet comprising an inner layer and an outer layer wherein the inner layer is oriented toward the inside of the package and the outer layer is oriented toward the outside of the package;
b. a first score line extending at least substantially into the inner layer but not extending into the outer layer;
c. a second score line extending at least substantially into the outer layer but not extending into the inner layer and being laterally offset from the first score line to define an opening panel in the package and a marginal region between the first and second score lines and to define a surrounding region of the sheet outside of the marginal region; and,
d. a cohesive disposed between the inner and outer layers in the marginal region and a laminating adhesive disposed between the inner and outer layers and extending substantially throughout the surrounding region.

26. The package of claim 25 wherein a portion of the marginal region is free of the cohesive.

27. A method of producing a reclosable package comprising:
a. providing a first substrate and a second substrate;
b. applying a releasable adhesive to the first substrate;
c. joining the first substrate to the second substrate;
wherein the releasable adhesive is chosen so as to allow a portion of the releasable adhesive to transfer to the second substrate during the joining operation and wherein the releasable adhesive allows the two substrates to be repeatedly separated and adhesively rejoined.

28. The method of claim 27 wherein the first substrate and the second substrate are laminated together.

29. The method of claim 28 wherein the releasable adhesive is applied to a first region of the first substrate.

30. The method of claim 29 wherein a permanent adhesive is applied to a second region of the first substrate.

31. The method of claim 30 where the second region is different from the first region.

32. The method of claim 27 wherein the releasable adhesive is a mixture of two adhesives.
